(19) United States
(12) Patent Application Publication
(10) Pub. No.: US 2006/0085237 A1
(43) Pub. Date: Apr. 20, 2006

(54) Method of improving information technology processes of a business using value stream management

(76) Inventors: Thomas J. Shuker, Grand Rapids, MI (US); James E. Luckman, Carmel, IN (US)

Correspondence Address: Miller, Canfield, Paddock and Stone P.L.C.;c/o Robert Kelley Roth, Suite 2500, 150 West Jefferson Ave, Detroit, MI, 48226, US

(21) Appl. No.: 11/230,447

(22) Filed: Sep. 20, 2005

Related U.S. Application Data
(60) Provisional application No. 60/611,319, filed on Sep. 20, 2004.

(51) Int. Cl. G06F 9/44

(52) U.S. Cl. 705/7

(57) ABSTRACT

A method for improving an information technology process of a business comprises the steps of selecting an administrative value stream having a series of steps, preparing a current state value stream map corresponding to the administrative value stream, preparing a future state value stream map based on lean concepts to create a future state administrative value stream, and defining a future state information technology process of the administrative value stream using learning cycles.

### RELATED APPLICATION

This application claims priority benefit of U.S. provisional patent application No. 60/611,319 filed on Sep. 20, 2004.

### FIELD OF THE INVENTION

This invention relates to improvements in methods for tracking and controlling administrative functions in a business, and more particularly to using an enterprise value stream method for defining and implementing information technology processes which are applied to the administrative functions of the business.

### BACKGROUND OF THE INVENTION

Each business has a series of steps or functions it uses to make a product or provide a service. Traditionally these business steps range from initial customer order to final customer delivery and have been organized based on function (engineering, sales, shipping and receiving, accounting, information technology, etc.). A value stream can be thought of as all of the steps required to enable a business to provide its customer with the desired goods or services. A value stream map is a tool to display the flow of material and information as they move through the value stream. Value stream maps can reflect the current state of business steps and can also reflect a future state of business steps. Value stream mapping have been used by manufacturing companies to help describe their manufacturing processes. It has typically been thought that administrative processes, were relatively immune to improvements through lean concepts and value stream mapping. This was because significant elements administrative processes were thought not to be visual (i.e., not easily mapped and monitored), and because of the lack of standardization in administrative processes. The only administrative processes addressed using lean concepts has been scheduling of materials in a manufacturing process, which is closely related to manufacturing processes.

U.S. Patent Publication 2004/0039625 to Malnack et al discloses a value stream process management approach and website, but does not disclose the use of current state value stream mapping, or any techniques for improving a current state map once it is created.

Information Technology processes can be considered as an example of administrative processes of a business. The known approach taken to implement a new Information Technology process typically starts with a request by a business or part of a business to implement the new process, typically an attempt to automate an existing process by incorporating various new software modules and possibly new computer hardware. The request is made to either an internal information technology department or to a consultant or other outside party such as a software provider (SAP, EDS, etc). The traditional approach then taken is to meet with the business requesting the software and review a process flow diagram of the process as it currently exists. From this meeting and process flow diagram review the IT department or outside party develops new software for the requested process. As the new software is developed, there is usually interaction with the people who work on the process with questions raised pertaining to the required outputs based on the process flow diagram. The typical result is a software module following the process flow as given initially. The new software does not work well initially, and effectively automates many wasteful process steps. Traditionally the process flow diagrams that software writers rely upon are not being followed and workarounds that were put in place to achieve the final output continue to exist.

Often, implementation of the new software is associated with discovery of the workarounds and eventually requires altering the software, at a significant cost penalty to the business. Additional internal or external programmers are required to rewrite the code to change the process. Further, there is no assurance that the next revision of software will avoid incorporating non-value added steps in the process. It would be highly desirable to provide a process to identify the initial waste in the Information Technology process and identify the workarounds prior to implementation of the new software.

### SUMMARY OF THE INVENTION

In accordance with a first aspect, a method for improving an information technology process of a business comprises the steps of selecting an administrative value stream having a series of steps, preparing a current state value stream map corresponding to the administrative value stream, preparing a future state value stream map based on lean concepts to create a future state administrative value stream, and defining a future state information technology process of the administrative value stream using learning cycles.

From the foregoing disclosure and the following more detailed description of various preferred embodiments it will be apparent to those skilled in the art that the present invention provides a significant advance in the technology for defining, controlling and improving administrative functions in a business. Particularly significant in this regard is the potential the invention affords for providing an improved method incorporating information technology requirements into the process of improving administrative functions in a business. Additional features and advantages of various preferred embodiments will be better understood in view of the detailed description provided below.

### BRIEF DESCRIPTION OF THE DRAWINGS

FIG. 1 is a flow chart showing representative administrative value streams in a business, any of which can include information technology processes.

FIG. 2 is a flow chart that outlines the process for improving information technology processes of a business using the value stream mapping process in accordance with a preferred embodiment, where information technology (“IT”) processes are defined using learning cycles.

FIG. 3 is a table showing the lean concepts or techniques that are used to create a future state value stream map.

FIG. 4 is a flow chart showing a process for defining IT processes in accordance with a preferred embodiment.

FIG. 5 is a table of a Representative Learning Cycle in accordance with a preferred embodiment, showing five different stages of a learning cycle.

FIG. 6 is an example of a Future State Map of Information Technology Process Development in accordance with a preferred embodiment.

FIGS. 7A-7B show an example of a current state value stream map for a pricing process entitled Product Cost Development Material Budget.

FIGS. 8A-8B show an example of a future state value stream map created from the current state value stream map of FIGS. 7A-7B using lean concepts.

FIG. 9 is an example of a current state value stream map for a patient clinic visiting process.

FIG. 10 is an example of a future state value stream map created from the current state value stream map of FIG. 9 using lean concepts.

FIG. 11 is a before and after table comparing the current administrative value stream of FIG. 9 with the future administrative value stream of FIG. 10.

It should be understood that the appended drawings are not necessarily to scale, presenting a somewhat simplified representation of various preferred features illustrative of the basic principles of the invention. The specific features of the method disclosed here will be determined in part by the particular intended application and use environment. Certain features of the illustrated embodiments have been enlarged or distorted relative to others to enhance visualization and clear understanding. In particular, thin features may be thickened, for example, for clarity of illustration. All references to direction and position, unless otherwise indicated, refer to the orientation illustrated in the drawings.

### DETAILED DESCRIPTION OF CERTAIN PREFERRED EMBODIMENTS

It will be apparent to those skilled in the art, that is, to those who have knowledge or experience in this area of technology that many uses and design variations are possible for the method disclosed here. The following detailed discussion of various alternative and preferred features and embodiments will illustrate the general principles of the invention with reference to improved administrative functions of a business, and in particular improved information technology processes of the business. Other embodiments suitable for other applications will be apparent to those skilled in the art given the benefit of this disclosure.

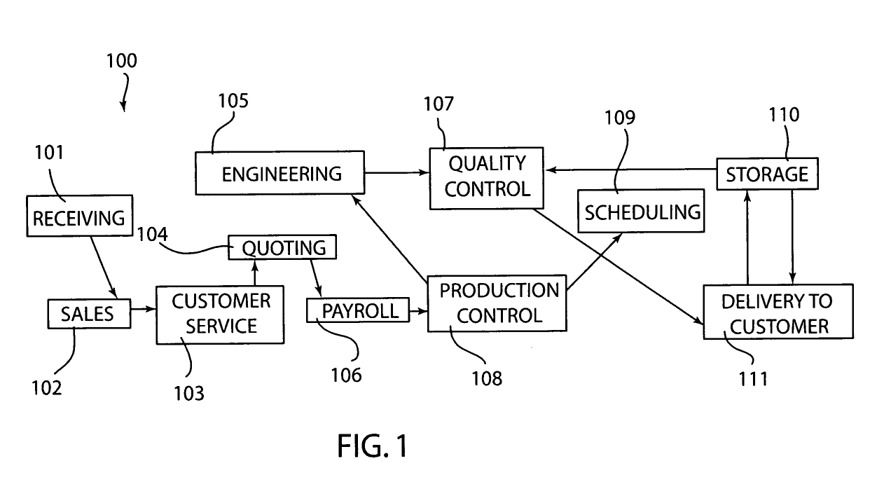

Referring now to the drawings, FIG. 1 shows a flow chart 100 of representative departments of a conventional business, organized by function, including receiving 101, sales 102, customer service 103, quoting 104, engineering 105, payroll 106, quality control 107, production control 108, scheduling 109, storage/warehouse/inventory 110, and delivery to customer 111. Information technology processes can apply to any and all of these departments, either alone or in combination, and typically comprise software modules and hardware components. As noted above, value streams are defined as all the steps required to complete a business process, starting with customer order and ending with customer delivery of a good or service. Administrative value streams would include non-manufacturing related value streams and service value streams, such as health care value streams. Some anticipatory and monitoring elements of an administrative value stream may occur prior to order entry and after customer delivery.

Examples of concept-to-launch value streams comprise, for example, a drafting release process, a product development process, a pricing process (for goods, services, or both), a procurement of raw materials or services process, an engineering proposal process, a process for customer ordering and/or preparation of quotes for the customer, and a quality control plan release process. These value streams support a product or service that is ordered by the end customer. Examples of order-to-cash value streams comprise, for example, an order lead time process, a customer return process, a contested invoice process, a month end closing process, a new hire application process, a drafting revision process for updating documents, including CAD drawings, a product enhancement process, a clinic visit process, a clinic discharge process, and a coordination of fringe benefits process. Other information technology processes which are components of one or more value streams will be readily apparent to those skilled in the art given the benefit of this disclosure.

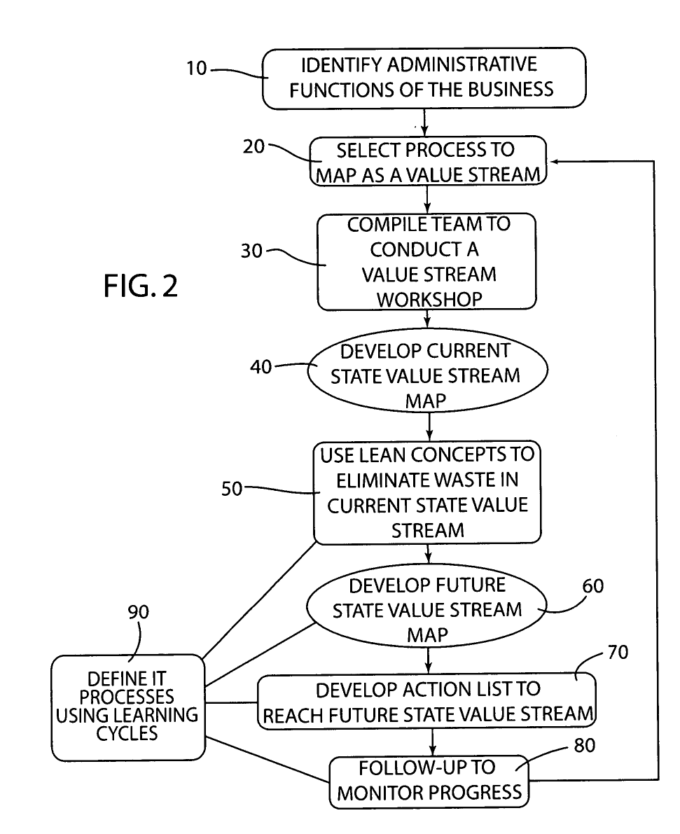

FIG. 2 is a flow chart which provides a broad overview of the value stream process 10, particularly tailored for improving IT processes. The series of steps in the process is described as follows.

10 Preparation phase. Identify the administrative business functions or group of functions of a company. Generally, business functions can be treated as one of several groups of value streams: concept-to-launch value streams and order-to-cash value streams are administrative value streams, and raw material-to-finished goods is a manufacturing value stream, and information technology processes can be considered any of these administrative value streams. Administrative value streams typically have one or more inputs from other value streams, and one or more outputs to other value streams. Inputs are the product or service of the initial or previous step in the process and can include, for example, a request for a quotation, a request for a purchase order, or an account payable. Outputs are the deliverable(s) to the next step or the ultimate end customer of the value stream and can include, for example, preparation of a quote, preparation of a purchase order, or payment on an account payable. Generally, administrative value streams receive inputs from upstream administrative value streams or suppliers and send outputs to downstream administrative value streams or customers. The terms suppliers and customers are used here only to refer to their location in the process flow relative to a selected administrative value stream. Thus, a given administrative value stream may be a customer in one instance and a supplier in another, depending on the selected administrative value stream.

At Step 20 an administrative function or process is selected for mapping as a value stream. This step involves prioritization of actions to be taken to improve administrative business functions.

Step 30. Compile a group of workers which forms a team to conduct a value stream workshop. Preferably the members of the workshop include workers experienced with the details of the selected administrative value stream. Further, the members of the workshop should include workers experienced with the details of administrative value streams which occur immediately before the targeted administrative value stream (“upstream,” or “suppliers”), and should include workers experienced with the details of administrative value streams which occur immediately after the targeted administrative value stream (“downstream,” or “customers”). As IT processes are often part of the value streams which are targeted for improvement, representatives of the IT department of the business are preferably members of the value stream workshop.

40 Draw a Current State Value Stream Map of the selected Administrative Value Stream. In accordance with a highly advantageous feature, each Current State Value Stream Map has at least the following five elements:

1. A list of all of the steps required to complete the administrative value stream.

2. A lead time for each step. The lead time is the amount of time it takes to complete each step, and is also the amount of time between steps. A total lead time is the sum of all of the lead times.

3. A process time for each step. Process time is the amount of time a worker spends actually working on a process step. This can be as much as the lead time, but not more than the lead time. A total process time is the sum of all of the process times.

4. A percentage correct and/or accurate of a given administrative value stream. A step has an input (which can include material worked on at a given step), and not necessarily all inputs are accurate. This metric determines the percent correct and accurate of the input data at that step. The Current State Value Stream Map records the rate of accuracy both at given steps and as a total percent correct. The total percent correct is the multiplier of the percent corrects at any given step in the map.

5. An information flow between steps. Information flow can comprise inputs required, including multiple inputs and inputs required from more than one other value stream) and outputs, including multiple outputs and outputs to more than one other value stream. The information flow is preferably represented on the Current State Value Stream Map as lines or arrows connecting steps.

In addition, each Current State Value Stream Map may further comprise one or more of the following:

1. A value added time for each step. This is the productive time spent actually adding value to the work done at a step. It is usually significantly less than the lead time working on a step. Optimally value added time would be equal to the process time.

2. A number of workers required for each step.

3. A number of times rework is done or revisions are required.

4. An identification of the kind of information technology used. This can be helpful in identify incompatible or semi-compatible software and hardware systems.

5. A batch size. Examples of batch size include for example, one whole days worth of purchase orders to be processed, or one whole week of accounts payable. Generally, when using lean concepts, it is desirable to reduce batch size.

6. A range of lead times for each step of an administrative value stream, an average for the lead time of all of the steps, and a standard deviation for all of the lead times for the given administrative value stream.

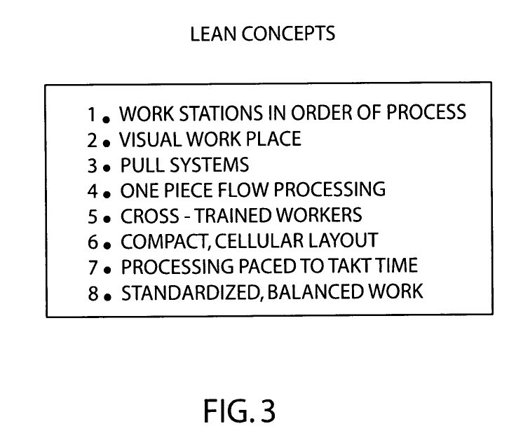

50 Use lean concepts to identify waste and inefficiency in the current state. In accordance with a highly advantageous feature, the current state value stream map is analyzed using at least one (and most preferably all) of several lean concepts. These lean concepts comprise, for example, the list on FIG. 3, discussed in detail immediately below.

1. Organizing work stations (a place where a worker works) in the order of each step of an administrative value stream (i.e., by work flow), in contrast to traditional organization of work stations by function.

2. Presenting a visual status of the administrative value stream to workers working on that value stream. This may take the form of posters mounted on a wall indicating work flow, or an electronic presentation. Provisions may be made for updating the visual status as steps of the administrative value stream are completed, and for providing data for monitoring the administrative value stream.

3. Balancing workflow between steps of the administrative value stream. Each step has a lead time. Generally, it is preferably to have the lead times be as short as possible. It is advantageous that the lead times between steps be similar, as workers work at each step can be made more even and more equitable. Thus, a standard deviation of lead times for a given administrative value stream should be as small as possible.

4. Reducing Batch size. Large batch sizes can overwhelm a process, making it difficult to balance steps and reduce overall process time.

5. Cross-training workers. Advantageously cooperating with the lean concept of balancing workflow is cross-training of workers. The amount of work to be done at each step is (if balanced) roughly the same, and so, it is easier for cross-trained workers to fill in for one another. Also, cross-training is advantageous for boosting morale by providing a better understanding of the work or others in the organization and by providing new intellectual stimulation at work.

6. Tying information together on the administrative value stream, instead of merely organizing workers by function. This advantageously reduces the amount of time spent traveling between workers, reducing overall process time.

7. Setting a pace of the administrative value stream based on available time divided by customer demand. Takt time is defined as available time for a process divided by customer demand so that product flows at a rate determined by the customer. Takt time is a useful measurable for establishing the rate or pace the administrative value stream needs to produce to meet customer demand.

8. Standardizing work done by different workers working on the same administrative value stream. This involves agreeing on a set of procedures for performance of work as it is done by different workers working on the same administrative value stream.

Returning to FIG. 2, Step 60 comprises drawing a Future State Map. This Future State Map reduces lead time for each step, the overall lead time for all of the steps, the standard deviation of the lead time for all of the steps of a given administrative value stream, the process time for each step, and rework inside the process, using the lean concepts discussed above.

70 Develop an action list describing what will happen and when it will happen to implement the future state administrative value stream. This list would preferably include new requirements for the IT department to develop new software to help create the future state. The future state administrative value stream may be checked for potentially patentable subject matter.

80 Monitoring the implementation of the future state administrative value stream. If necessary, the process may be repeated.

Since most administrative processes have elements which are performed on computer, the software needed to support the new process as defined by the future state value stream map has to be developed. Each of the last several steps of FIG. 2 can have IT processes associated with them that can be improved: 50 using lean concepts to eliminate waste in the current state value stream; 60 developing a future state value stream map with improved IT processes; 70 developing an action list to reach the future state value stream; and 80 following-up to monitor progress, may be applied to IT processes. In accordance with a highly advantageous feature, the IT processes for each of these steps are defined using learning cycles at step 90.

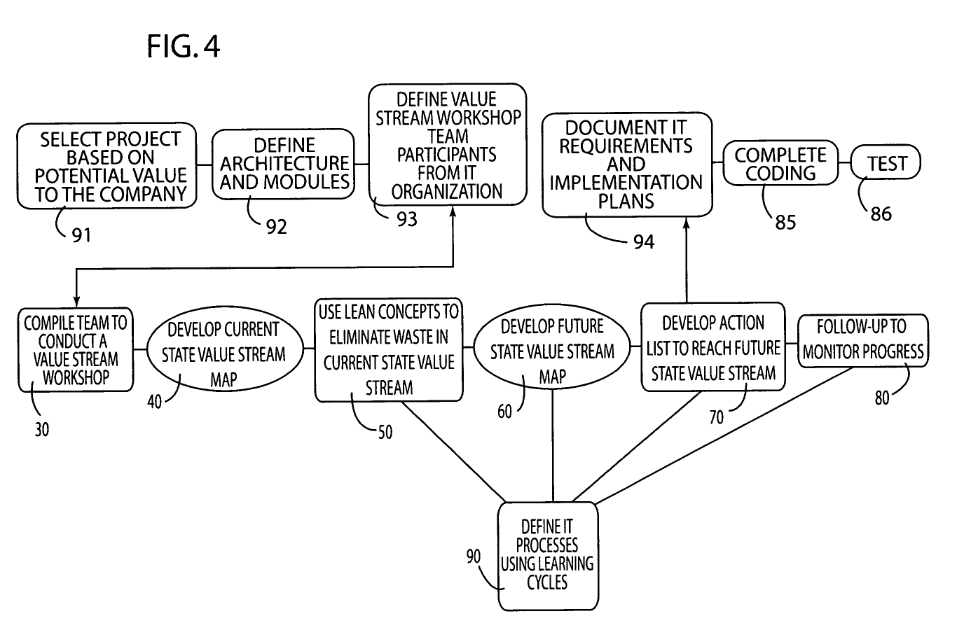

FIG. 4 shows a representative method that a business uses learning cycles to define future state IT processes to support administrative value streams in accordance with a preferred embodiment. At step 91, a process is selected based on its estimated potential value to the business. The ranking of projects based on potential value is preferably done by management in combination with individuals from the IT department of the business. The IT department of a business can then define the necessary software and computer hardware (either alone, or in combination with outside software vendors) needed for the future state administrative value stream, Step 92. At step 93, IT employees are established to work with the process owners (people at the business responsible for a given administrative value stream, sometimes also referred to as “customers” for a given process) and others on the value stream workshop tasked with creating the future state value stream map. Once these IT individuals have been identified and the workshop participants established, they are incorporated into the team which conducts the value stream workshop at step 30, as in FIG. 2. Steps 30 to 70 follow as in FIG. 2. The development of the action list to reach the future state value stream typically includes an action list of IT processes which need to be upgraded. As part of its overall duties, the workshop documents the IT processes and develops implementation plans. Step 94. Charts may be created to help manage the process, allow members of the workshop to better understand their roles, and create the framework for the action list to reach the future state value stream map.

Advantageously, implementation of the action list for the new IT processes is preferably delayed until the process requirements are well understood, reducing the need for repeating steps and for inefficient post-workshop corrective actions. At step 85, the IT organization develops software code needed for the future state value stream. At step 86, the new code is tested and debugged. The creation of future state IT processes helps improve delivery and performance and also reduces waste and cost in administrative processes prior to determining what software modules and computer hardware are needed. Developing future state IT processes in this way is advantageous to the business in allowing it to take structural costs out of its processes and realize ongoing savings year after year. It is also advantageous to a developer of the software (especially when the developer is an outside company) because the developer will now supply more value added features, beyond just off the shelf software that works only with a process filled with wasted motion and processes. That is, the software developer would not only provide a solution for providing software to perform the future state administrative process, but also have an enhanced product which can be sold to other businesses with similar administrative value streams.

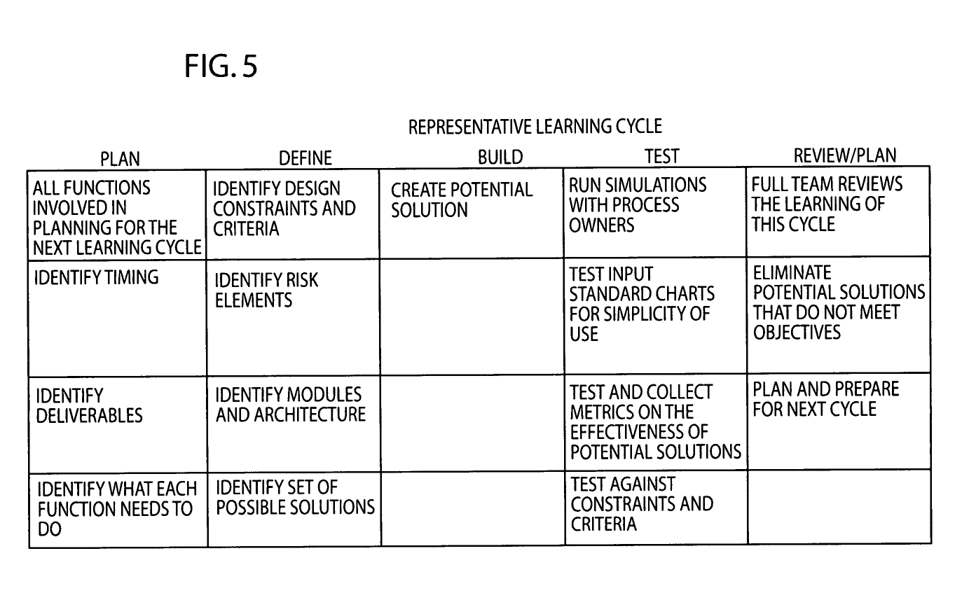

FIG. 5 is a table which discloses a representative learning cycle used for defining the IT processes for a future state administrative value stream. Learning cycles may be used repeatedly and emphasize the use of simulations and prototyping. Learning cycles are used to test proposed IT improvements. Preferably, set based concurrent designs may be created and tested in parallel to improve the quality of the future state value stream and to reduce the time to its implementation.

The five stages of a representative learning cycle are: plan, define, build, test and review/plan. In the first stage, planning, all functions in the administrative business process are identified, along with what each function does, each functions timing and the deliverables or outputs of each function. At the next stage, the define stage, design constraints, risk elements, software modules, architecture and computer hardware are identified for a proposed future state IT process, along with a set of possible solutions for a future state IT process. At the build stage, potential solutions for improving administrative business processes are simulated. Next, at the test stage, the set of solutions are simulated with the administrative business process owner. The test phase can comprise several different elements, including testing for several kinds of proposed standardized charts for data entry or other inputs, testing measurable outputs and performing a quality check using quality function deployment and design for six sigma techniques to evaluate each solution. The test stage collects measurable data on the effectiveness of the one or more proposed and tested solutions. This may include testing to certain constraints and other criteria identified as a deliverable in the plan stage.

The last stage of the learning cycle is review/plan. Here, the value stream workshop team reviews the test results and eliminates potential solutions that do not meet the objectives, i.e., are not able to satisfy the requirements of the deliverables identified in the plan stage. If additional learning cycles are required, the process may be repeated.

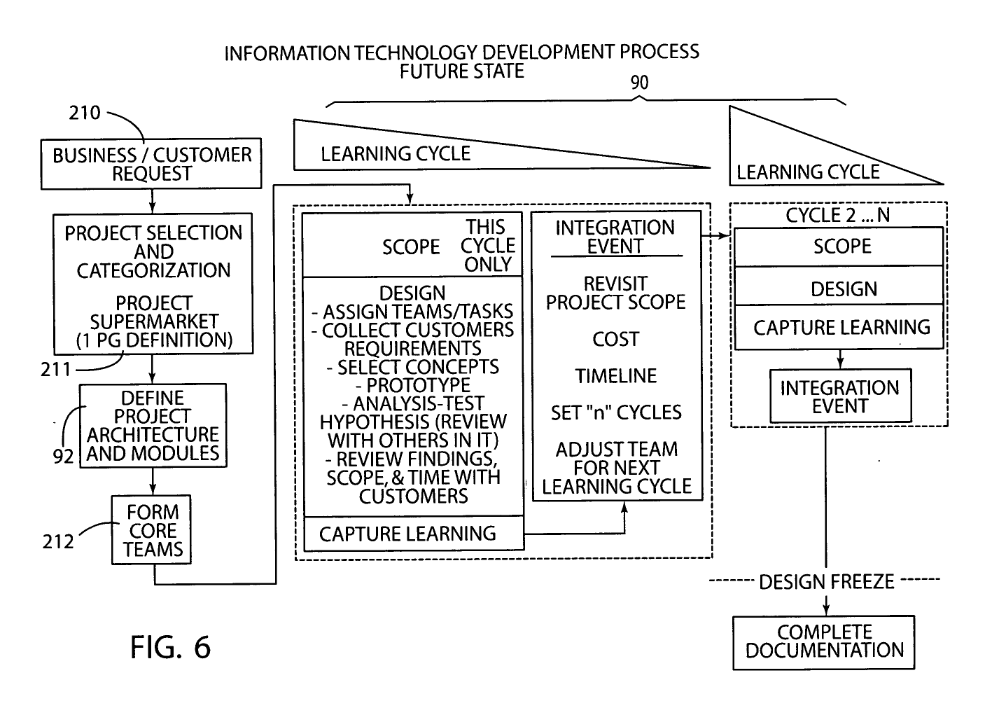

FIG. 6 is an example of a Future State Value Stream Map for an Information Technology Development process for a business. This can be used for a series of IT projects for developing future state administrative value streams throughout the business. A current state may have numerous problems, including, for example, initiating processes without establishing their value to the business, disorganization and lack of discipline in the process, lack of authority to slow down or cancel a project, no standard references or measureables, delay and lack of responsiveness between groups, changing priorities in the middle of projects and conflicting priorities, etc. The Future State map and learning cycles are used to help correct these kinds of errors and reduce waste. At step 210, the business makes a request of its IT department to develop one or more future state IT processes. At step 211, the IT department, working with the customer/business, identifies a set of projects which can be implemented. These can be summarized in a project supermarket document, which is preferably a one page definition of each IT process. At step 92, the software modules and computer hardware needed for the IT process are defined. Next, core teams are formed, Step 212. The core team is responsible for implementing the future state IT process. The team uses one or more learning cycles 90. As shown in FIG. 6, this comprises identifying the scope of the IT process (planning and defining), designing the tests (build), capturing learning (test), and an integration event (review/plan). The first cycle has additional elements beyond future cycles, as the planning and design stages are usually larger. For example, through each learning cycle, some questions are answered and some deliverables are achieved. Further, the integration event is at the end of the first learning cycle, and is used to determine the number of cycles required. At the design stage, the team assigns tasks, collects requirements of the business, selects concepts to prototype, and sets up the experiments to determine the best way to develop the future state value stream map. The testing allows the group to capture information about the various concepts prototyped.

The integration event is typically a meeting, preferably held about one week after the initial formation of the core team. At this meeting the scope of the project is reviewed, costs of prototype processes are determined and compared with current state costs, a timeline is established for completion of tasks, and the number of cycles, n, is set. The composition of the team may be adjusted for the next learning cycle. FIG. 6 shows additional learning cycles repeating as needed, from cycle 2 to cycle n. Preferably the number of learning cycles n have been completed prior to implementation of the future state IT process. That is, the design is frozen until the learning cycles have been completed, and only then implemented (with complete documentation, including documentation for software coding), advantageous eliminating wasted efforts correcting errors.

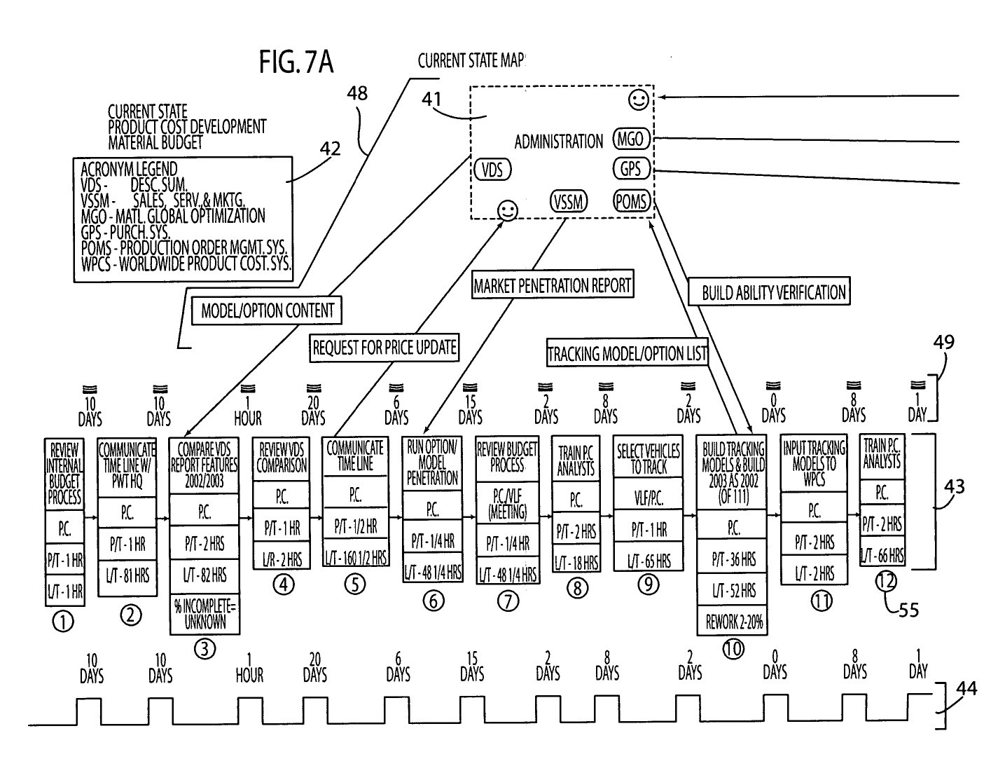

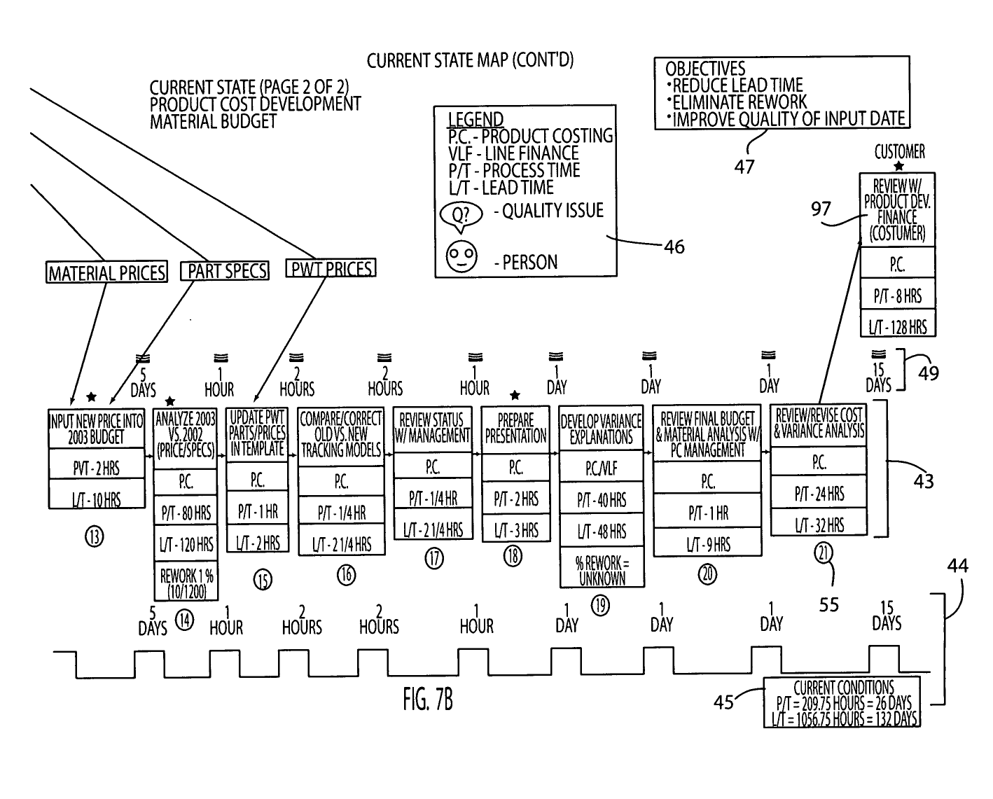

FIGS. 7A-11 disclose various examples of administrative processes improved using value stream maps. FIGS. 7A-7B provide an example of a current state administrative value stream map. In this case, the administrative function is a concept-to-launch value stream, a pricing process called “Product Cost Development.” A team was created and a workshop convened. Principle goals of the value stream mapping workshop was to reduce cost and lead-time. Generally, other goals of a value stream mapping workshop comprise increasing quality, reducing information flow and increasing percent correct and accurate at each step. Information technology processes here can include the use of cost estimate software. The current state map in FIGS. 7A-7B has been developed with the assistance of those experienced with the given administrative value stream, including those who perform the processes each day. The current state value stream map includes both material and information flow. The current state map allows team members to see and agree on how the process currently operates in order to bring a product or service to completion.

In this exemplar map, there are twenty-one steps 55, shown in a row of process and data boxes 43. Process and data boxes identify the step, show lead times and process times, and where applicable (as in steps 3,10,14 and 19) a percentage correct or accurate. The lead times are shown twice, once in row 49 above the row 43 and once below row 43 in row 44 in a slightly different format. To help simplify the map and increase the amount of information that can be placed on the map, acronyms are used. An acronym legend 42 is provided on FIG. 7A and another legend 46 is provided on FIG. 7B. For example, a stylized Q is provided to indicate places where the data may be somewhat subjective or difficult to quantify. FIG. 7A shows an administration box 41 with various acronyms referring to elements of administration. The smiley face is representative of a person. Information flows 48 are shown and labeled, and where the information flows to a person, a smiley face is used. FIG. 7B completes the current state value stream map, and has a list of objectives 47, an end customer or customers 97 which receives outputs, and a summary box 45 which lists total lead time and total process time.

The team used lean concepts to identify waste within the administrative value stream. The following types of waste were reviewed:

Overprocessing—performing more work than is needed

Overproduction—performing the work faster than is needed

Correction—reviewing for or making errors

Waiting—waiting for responses or information to complete the task

Motion—excess movement to complete the task

Inventory—excess work that needs to be completed

Material Movement—moving material to the next process.

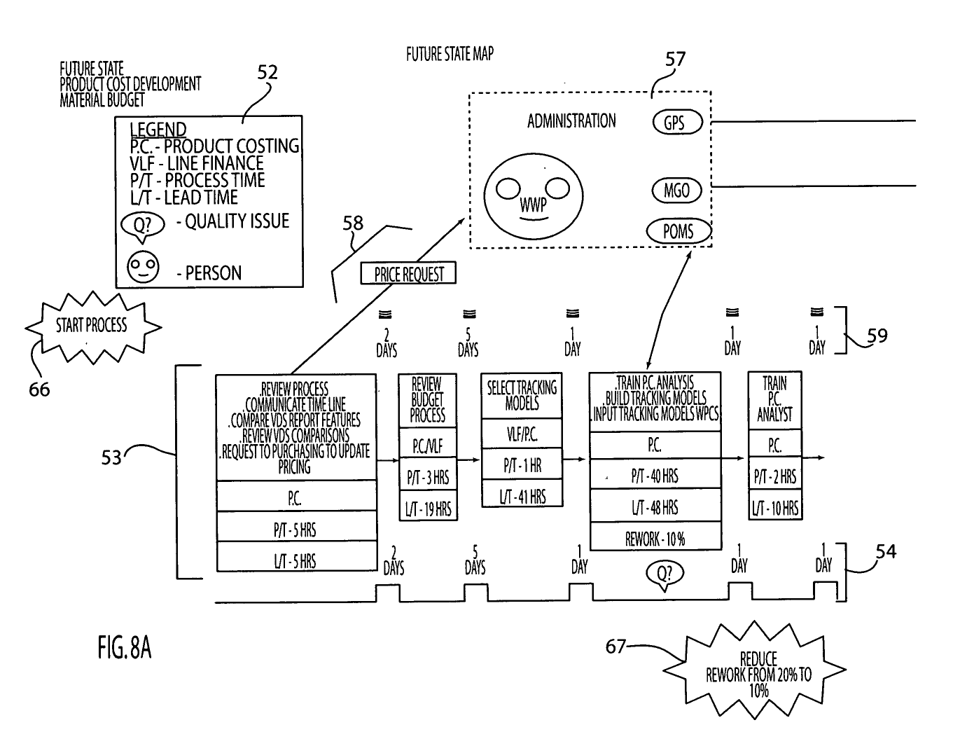

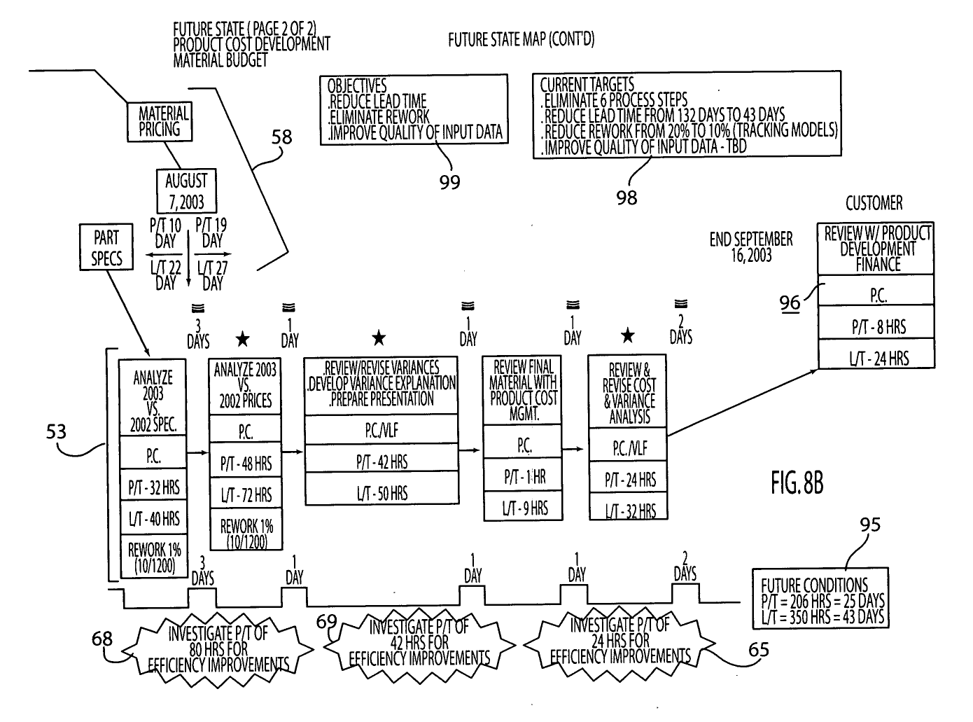

The team then worked to develop a future state administrative value stream map. This is a map of how the team thinks the process will operate, with as little of the waste identified as possible. FIGS. 8A-8B shows an example of a future state administrative value stream map for the pricing process called “Product Cost Development” based upon the corresponding current state administrative value stream map shown in FIGS. 7A-7B. Using lean concepts, the number of steps has been reduced from 21 to 11, the total lead time has been reduced from 132 days to 43 days, and the total process time has been reduced from 26 days to 25 days. (See Summary box 98 in FIG. 8B).

As before, a legend 52 is provided, and an administrative box 57. Starbursts 65-69 on the future state administrative value stream map represent kaizen or continuous improvement actions that should occur to reach the future state process. At each starburst, the team is to prioritize the continuous improvement actions and assign champions and completion dates to each action to ensure that they are completed. This serves as part of a visual tool for an action list for implementation of the future state. Future state work flows 58 are shown, along with future state data and process boxes 53 and future state lean times 54 and 59. A list of objectives 99 is provided, along with a goal list 98 of current measurable targets. The receiving agent of the outputs is the end customer(s) 96. A summary box 95 shows total lead time and total process time for the future state administrative value stream.

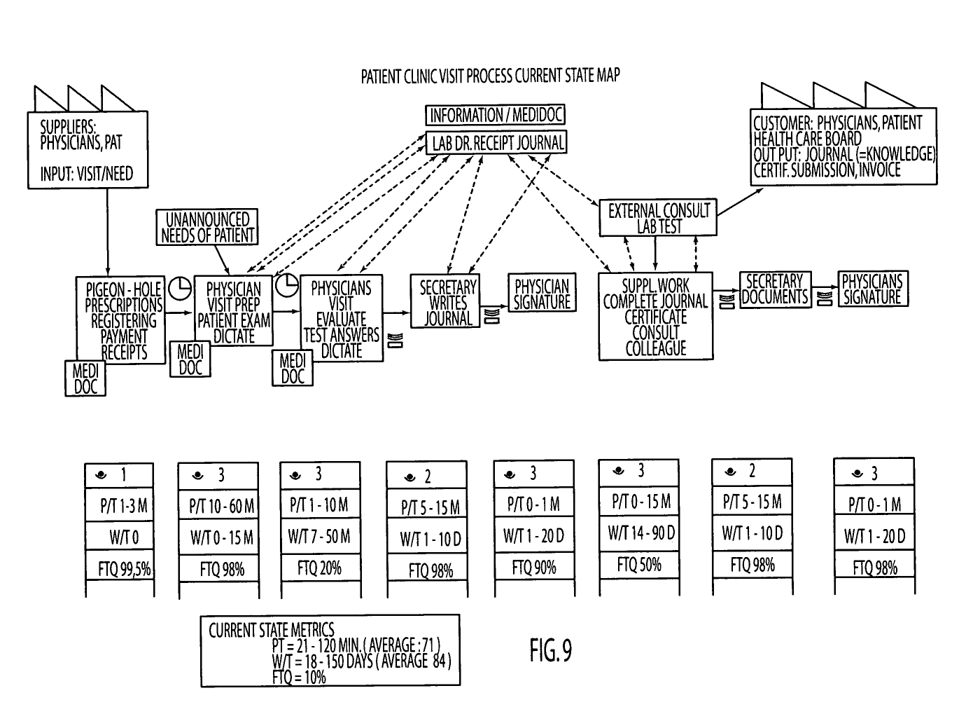

FIG. 9 provides an example of another current state administrative value stream map, an order-to-cash value stream entitled “Patient Clinic Visit Process”. Information work flow 228, data and process boxes 229, and a summary box 230 are provided. The summary box 230 provides total lead time, total process time and total percentage correct. Information processes may include input of patient information, tracking of patient procedures, and tracking of payments and costs.

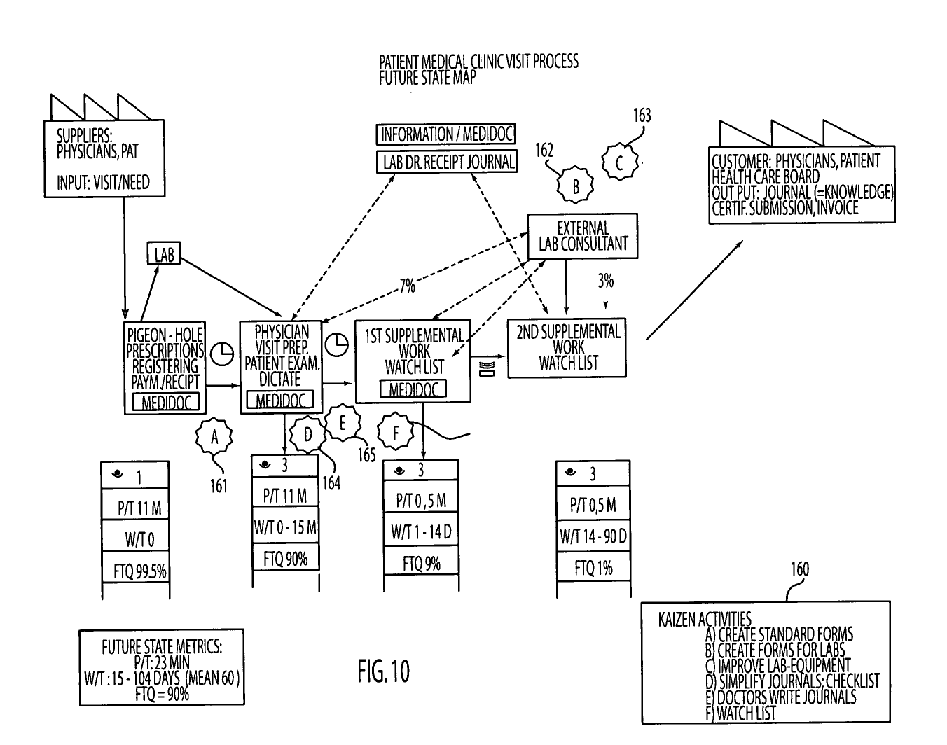

FIG. 10 provides an example of a future state administrative value stream map, based on application of lean concepts to the Patient Clinic Visit Process of FIG. 9. Kaizen activities 161-166, similar to the starbursts of FIG. 7B, are labeled in box 160. A work flow 338 is shown, along with data and process boxed 339, and a summary box 330 entitled “Future State Metrics”.

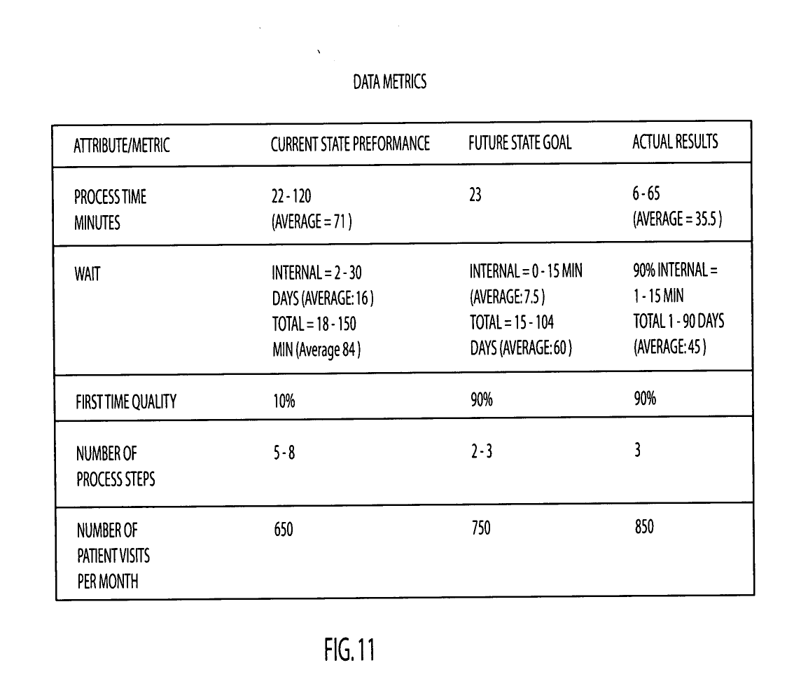

Box 330 is not a report of the actual measurements upon implementation of the future state administrative value stream. Rather, these metrics represent measurable goals. FIG. 11 is a comparison of the data metrics generated from the current state administrative value stream map of FIG. 9 and the future state administrative value stream map of FIG. 10, with the actual results after implementation. Thus, the actual results are monitored for comparison with what was expected to be achieved in the future state map.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for improving an information technology process of a business comprising, in combination, the steps of:
selecting an administrative value stream having a series of steps;
preparing a current state value stream map corresponding to the administrative value stream;
preparing a future state value stream map based on lean concepts to create a future state administrative value stream; and
defining a future state information technology process of the administrative value stream using learning cycles.

2. The method of claim 1 further comprising the step of implementing the future state administrative value stream.

3. The method of claim 2 wherein information technology processes are defined by the steps of:
selecting the process based on potential value to the business;
identifying appropriate computer hardware and software modules;
compiling a team for a value stream workshop including participant from within an information technology organization in the business;
wherein the learning cycles are used by value stream workshop team to develop a future state value stream map.

4. The method of claim 1 wherein the learning cycle which defines the future state information technology process comprises the steps of:
planning, defining, building, testing and reviewing the plan after testing.

5. The method of claim 4 wherein the step of planning comprises identifying steps in the information technology process, describing what each step does, determining what amount of time is involved with the step, and listing outputs of each step.

6. The method of claim 4 wherein the step of defining comprises identifying design constraints, risk elements, software modules and a set of possible solutions for each step in a proposed future state information technology process.

7. The method of claim 4 wherein the step of building comprises building at least one prototype of a step in a proposed future state information technology process.

8. The method of claim 4 wherein the step of reviewing the plan occurs at an integration event.

9. The method of claim 8 wherein the number of learning cycles is set at the integration event at the first learning cycle.

10. The method of claim 1 wherein the administrative value stream comprises at least one of the groups of concept-to-launch value streams and order-to-cash value streams.

11. The method of claim 10 wherein the group of concept-to-launch value streams comprises at least one of:
a drafting release process;
a pricing process;
a procurement process;
an engineering proposal process;
a process for customer ordering and preparation of quotes for the customer;
a product development process; and
a control plan release process.

12. The method of claim 10 wherein the group of order-to-cash value streams comprises at least one of:
an order lead time process;
a customer return process;
a contested invoice process;
a month end closing process;
a new hire application process;
a drafting revision process;
a product enhancement process;
a clinic visit process;
a clinic discharge process; and
a coordination of benefits process.

13. The method of claim 1 wherein the current state value stream map contains at least:
a list of steps of an administrative value stream;
a lead time of each step;
a process time for each step;
a total percentage correct for the administrative value stream; and
an information flow between steps.

14. The method of claim 13 wherein the current state value stream map further comprises at least one of:
a value added time for each step;
a number of workers required for each step;
a number of times rework was done or revisions required;
an identification of the kind of information technology used;
a batch size; and
a range and average for the lead time for at least one of the steps of the administrative value stream.

15. The method of claim 1 wherein the lean concepts further comprise at least one of:
organizing work stations in the order of each step of an administrative value stream;
presenting visual status of the administrative value stream to workers working on that value stream;
balancing workflow between steps of the administrative value stream;
reducing batch size;
cross-training workers;
placing workers together who work together on the administrative value stream;
setting a pace of the administrative value stream based on available time divided by customer demand; and
standardizing work done by different workers working on the same administrative value stream.

16. The method of claim 1 wherein a first administrative value stream which occurs before a second administrative value stream is upstream of the first administrative value stream, and a third administrative value stream which occurs after a second administrative value stream is downstream of the second administrative value stream, and further comprising the step of:
selecting a group of workers to select the administrative value stream, prepare a current state value stream map, and prepare a future state value stream map based on lean concepts;
wherein the group of workers comprises workers experienced in the administrative value stream, workers experienced in the upstream administrative value stream, and workers experienced in the downstream administrative value stream.

17. The method of claim 1, after the step of implementing the future state value stream, further comprising the step of
monitoring implementation of the future state administrative value stream.

18. The method of claim 1 further comprising the step of:
using a workshop to prepare the current state value stream map and to identify the future state administrative value stream.
